(19) United States
(12) Patent Application Publication
(10) Pub. No.: US 2004/0237255 A1
(43) Pub. Date: Dec. 2, 2004

(54) Multiple-function door handle

(76) Inventors: I-Huang Lin, Chung-Ho (TW); Jong-Min Lu, Chung-Ho (TW)

Correspondence Address: I-Huang Lin, P. O. Box 55-846, Taipei, 104, TW

(21) Appl. No.: 10/672,170

(22) Filed: Sep. 24, 2003

(30) Foreign Application Priority Data
Jun. 2, 2003 (TW) 92210111

(51) Int. Cl. E05B 7/00

(52) U.S. Cl. 16/110.1; 16/904

(57) ABSTRACT

A door handle includes a disinfection device provided in the handle for automatically or manually spraying disinfectant onto the surface of the handle in order to kill virus or micro-organisms existing on the handle for preventing the infection of SARS virus or other pollutants. The door handle further includes a fire alarm, a gas-leakage alarm and a burglar alarm formed in the handle for respectively warning a fire, a gas leakage and an intrusion accident for safety and security purposes.

### BACKGROUND OF THE INVENTION

In 2003, a new virus called Severe Acute Respiratory Syndrome (SARS) virus was spread from China to many countries in the world. Since it is a new developed virus, no vaccine or medicine is available to cure or treat such a virus. So, people are educated to wear masks, to clean hands frequently and to disinfect the public areas. The door handles in a public area, such as: a department store, a theater, a restaurant, etc., are required to be disinfected by spraying disinfectant thereto. However, such a disinfection work always requires cleaner's hard work and may increase financial burden for the relevant enterprises.

A conventional door handle is not provided with a fire alarm, a gas detector and a burglar alarm, thereby lacking of safety and security function. In case of fire in a large public place such as a department store, people are panic trying to escape and can not easily distinguish the initial fire location as smoke is spreading and blurring the vision. If the door handle were provided with a fire alarm or warning device thereon, it will indicate the people or the firemen about the fire location to guide a reliable way for escape or for fire fighting.

The present inventor has found these phenomena and invented the present door handle having multiple functions.

### SUMMARY OF THE INVENTION

The object of the present invention is to provide a door handle including a disinfection device provided in the handle for automatically or manually spraying disinfectant onto the surface of the handle in order to kill micro-organisms existing on the handle for preventing the infection of SARS virus or other pollutants.

Another object of the present invention is to further provide a fire alarm, a gas detector and a burglar alarm on (or in) the door handle for warning people of a fire, a gas leakage and a burglar intrusion.

### BRIEF DESCRIPTION OF THE DRAWINGS

FIG. 1 is a sectional drawing of the present invention.

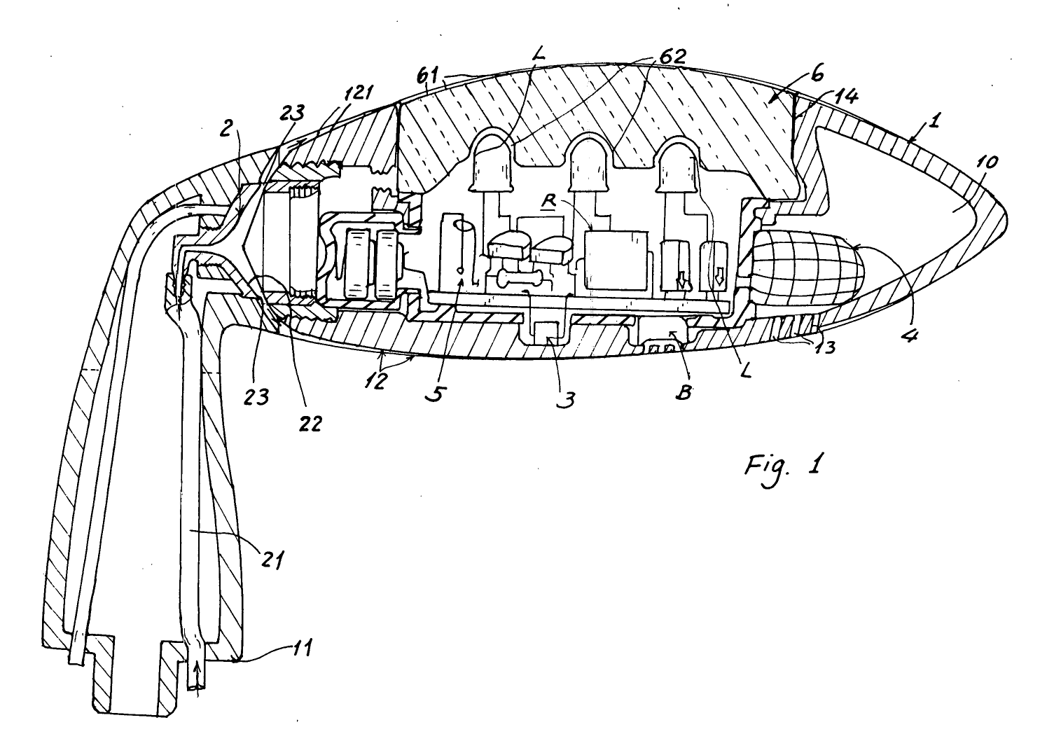

FIG. 2 is a top view illustration of the door handle of the present invention.

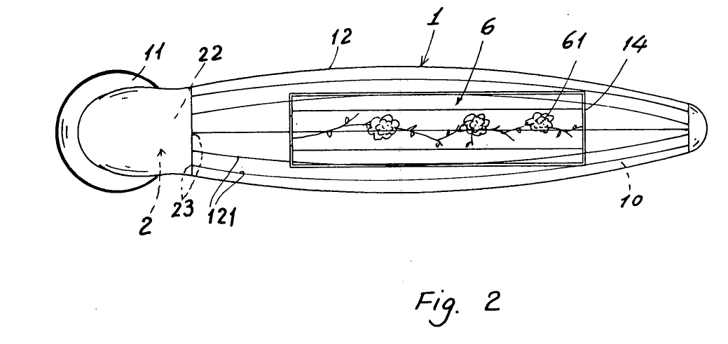

FIG. 3 is an illustration showing the disinfection device as mounted on a door.

FIG. 4 is a sectional drawing of another preferred embodiment of the present invention.

### DETAILED DESCRIPTION

As shown in the drawing figures, the multiple-function door handle apparatus of the present invention comprises: a door handle 1 rotatably mounted on a door D, a disinfection means 2 formed in the door handle 1 and in the door D; a fire alarm means 3, a gas alarm means 4 and a burglar alarm means 5 respectively formed in the door handle 1; and a decorative piece 6 embedded or secured in an opening 14 in the door handle 1 having planar or three-dimensional decorative feature 61 formed on the decorative piece 6. The decorative piece 6 is preferably made of transparent materials.

The door handle 1 includes an adapter 11 rotatably mounted on a door, a cabinet, a wardrobe or a container. The door handle 1 may be made of metal or any other fire-retarding materials, not limited in the present invention. The shapes of the handle 1 are not limited. An interior 10 in the handle 1 is provided to install the disinfection means 2, the fire alarm means 3, the gas alarm means 4 and the burglar alarm means 5 in the interior 10.

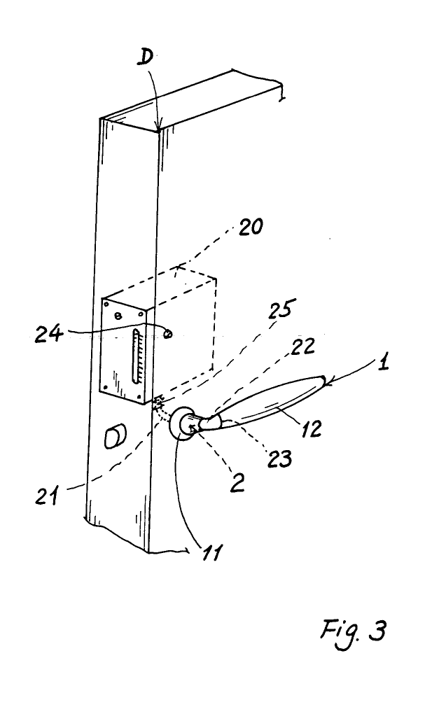

The disinfection means 2 includes: a disinfectant supplier 20 which may be mounted in a door D (or in a room) as shown in FIG. 3 for outwardly supplying disinfectant from the supplier 20; a spray nozzle 22 formed in the handle 1 and fluidically communicated with the disinfectant supplier 20 by a conduit 21; a plurality of spray holes 23 formed through the nozzle 22 and the door handle 1 for spraying the disinfectant outwardly to a surface portion 12 of the door handle 1 for disinfecting the handle 1; a sensor 24 formed on the door (or on the handle 1) for sensing a door opener when depressing the door handle 1 to open the door; and a valve 25 formed on the conduit 21 and operatively opened when the handle 1 is depressed and sensed by the sensor 24 for delivering the disinfectant to be sprayed onto the handle 1.

The spray holes 23 are fluidically communicated with a plurality of shallow grooves 121 longitudinally recessed in the surface portion 12 of the door handle 1 so that the disinfectant may be evenly distributed to the surface of the handle 1 through such grooves 121.

The surface portion of the handle 1 may be formed as porous structure by powder metallurgy to homogeneously distribute the disinfectant on the surface of the handle 1.

The sensor 24 may also be modified as an actuator to be manually actuated for opening the valve 25 for delivering the disinfectant onto the handle surface 12.

An automatic spraying system may also be provided for periodically opening the valve 25 for disinfecting the handle 1.

The sensor 24 may be a photo sensor such as operated by infrared rays; or a mechanical sensor, not limited in the present invention.

A boosting pump (not shown) is provided in the disinfectant supplier 20 for pumping the disinfectant outwardly with a sufficient pressure to be sprayed onto the handle surface.

City (utility) power or battery power may be provided for powering the electric or electronic elements of the present invention. The disinfectant supplier 20 may be modified as a general supply system installed in a control room or center.

Since the door handle 1 is disinfected automatically or manually in accordance with the present invention, the SARS virus or other micro-organism may be killed or disinfected to prevent from the spreading of SARS or the like, thereby being beneficial for public hygiene. For the multiple functions of the door handle in accordance with the present invention, further alarm devices as provided in the handle 1 are described hereinafter:

The fire alarm means 3 includes: a temperature sensor or smoke detector (or sensor) for sensing a high temperature or smoke as occurring in a fire accident; and an alarm operatively actuated by the sensor for warning the fire accident. The alarm includes: an optical (or photo) alarm L such as made of LEDs (light emitting diodes); a buzzer B; and a wireless alarm R which may be remotely communicated to a control center, a police station, a fire brigade, or an owner's headquarter. The optical (or photo) alarm L may indicate the fire location which may guide the firemen for an efficient to-the-point fire fighting and also for guiding the people for a safe escape or evacuation.

The temperature sensor of the above-mentioned fire alarm means 3 may include wax formed on a circuit breaker of the alarm circuit, whereby upon heating by a fire, the wax will be melted to break the circuit to actuate the fire alarm. Many modifications may be made in accordance with the present invention.

The gas alarm means 4 includes: a gas leakage detector (or sensor) installed in the handle 1 to sense leaking flammable or poisonous gas through perforations 13 formed through the handle 1; and an alarm, such as the aforementioned LED (L), buzzer (B) or wireless alarm (R), operatively actuated by the detector for warning the leakage of a hazardous or flammable gas in the surrounding.

The burglar alarm means 5 includes: an intrusion sensor which may be a vibration sensor or other suitable sensors for sensing an intruder such as a thief or robber when trying to open the door by depressing the door handle 14; and an alarm including LED (L), buzzer (B) and wireless alarm (R) operatively actuated by the intrusion sensor for warning an intrusion by the intruder (thief or robber). The alarm may be remotely connected to a police station in order to call for police.

By the way, a fire, a gas leakage or an intrusion accident may be sensed for actuating an alarm for warning the relevant people for enhancing their safety and security.

The door handle 1 further includes: the decorative piece 6 made of transparent material (such as glass, or crystal) embedded or formed in a front or upper portion of the handle 1; with the transparent decorative piece playing double roles both for decorative purpose and also for transmitting the optical alarm of LED (L) formed in the handle 1 through the transparent decorative piece 6. The optical alarm of LED can be a flashing light for a remarkable warning.

A light converging or diverging lens 62 having diamond-like structure may be disposed about each LED (L) of the alarm means to increase the brilliant visual or ornamental effect of the present invention.

The present invention may be modified without departing from the spirit and scope of the present invention.

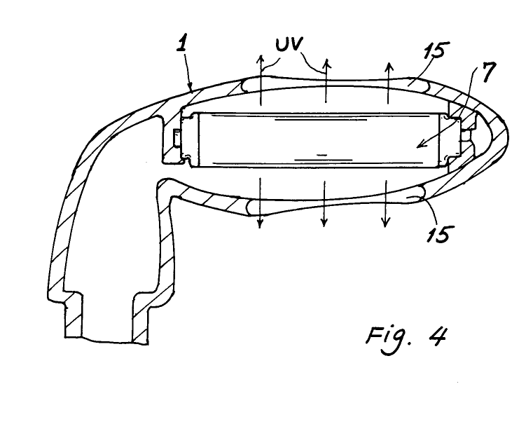

As shown in FIG. 4, an ultra-violet (UV) lamp 7 is provided in the door handle 1 for emitting ultra-violet rays outwardly through a plurality of windows 15 formed through the handle 1 for killing hazardous bacteria or virus on the handle.

I claim:

1. A door handle apparatus comprising:
a door handle rotatably mounted on a door; and
a disinfection means formed in the door handle and operatively delivering or spraying a disinfectant from said disinfection means onto a surface portion of said door handle for disinfecting the door handle.

2. A door handle apparatus according to claim 1, wherein said disinfection means includes a disinfectant supplier mounted in the door or in a room for outwardly supplying or boosting the disinfectant from said supplier, a spray nozzle fluidically communicated with said supplier through a conduit, a plurality of spray holes formed through the door handle and through said spray nozzle, a valve formed on the conduit, and means for operating or opening the valve for delivering or spraying the disinfectant from said supplier onto said door handle for disinfecting the door handle.

3. A door handle apparatus according to claim 2, wherein said means for operating the valve is selected from the group consisting of a sensor for automatically opening the valve and an actuator for manually opening the valve.

4. A door handle apparatus according to claim 1, wherein said door handle includes a plurality of grooves longitudinally formed in the surface portion of said handle to be fluidically communicated with said disinfection means for homogenously distributing the disinfectant from said disinfection means onto the surface portion of said door handle.

5. A door handle apparatus according to claim 1, wherein said door handle has the surface portion formed with porous material including powder metallurgy.

6. A door handle apparatus according to claim 1, wherein said door handle further includes an alarm means selected from the group consisting of a fire alarm means, a gas alarm means and a burglar alarm means for respectively warning a fire accident, a flammable or poisonous gas leakage accident, and an intrusion accident as intruded by a thief or a robber.

7. A door handle apparatus according to claim 6, wherein each said alarm means includes a sensor for sensing the accident and an alarm operatively actuated by said sensor for warning the accident; said alarm including a photo alarm including LED alarm, a buzzer and a wireless alarm.

8. A door handle apparatus according to claim 7, wherein said door handle further includes a transparent decorative piece formed in said handle for outwardly transmitting photo signal of the photo alarm of said alarm means through said transparent decorative piece, having a light converging or diverging lens disposed about the photo alarm for a brilliant visual effect.

9. A door handle apparatus comprising:
a door handle rotatably mounted on a door and having a plurality of windows formed through said handle; and
at least an ultra-violet lamp formed in said door handle for emitting ultra-violet rays outwardly through said windows for killing bacteria or virus on the door handle.
